(19) United States
(12) Patent Application Publication
(10) Pub. No.: US 2019/0347351 A1
(43) Pub. Date: Nov. 14, 2019

(54) DATA STREAMING BETWEEN DATACENTERS

(71) Applicant: HEWLETT PACKARD ENTERPRISE DEVELOPMENT LP, Houston, TX (US)

(72) Inventors: Annmary Justine Koomthanam, Bangalore (IN); Suparna Bhattacharya, Bangalore (IN); Madhumita Bharde, Bangalore (IN)

(21) Appl. No.: 15/978,218

(22) Filed: May 14, 2018

(51) Int. Cl. G06F 17/30; H04L 12/24

(52) U.S. Cl. CPC G06F 17/30575; H04L 41/084; H04L 41/0813

(57) ABSTRACT

Example techniques of data streaming between datacenters are described. In an example, a delta data may be replicated at a specific time interval from a first filesystem of a first stream-processing platform implemented at a first datacenter or source datacenter to a second filesystem of a second stream-processing platform implemented at a second datacenter or a target datacenter. The delta data indicates modifications to data of the data stream stored in the first filesystem, during the specific time interval.

### BACKGROUND

Data may be streamed between datacenters connected over a network. A datacenter is a facility composed of networked computers and storage that organizations use to process, store, and disseminate large volumes of data. Stream-processing platforms may be deployed in the datacenters for data streaming. The stream-processing platforms are capable of publishing and subscribing data streams, storing the data streams, and inline processing of the data streams.

### BRIEF DESCRIPTION OF DRAWINGS

The following detailed description references the drawings, wherein:

FIG. 1 illustrates a network environment where a first datacenter streams data to a second datacenter, according to an example;

FIG. 2 illustrates a target datacenter, according to an example;

FIG. 3 illustrates a network environment where a first datacenter streams data to a second datacenter, according to an example;

FIG. 4 illustrates a method for streaming data from a first datacenter to a second datacenter, according to an example;

FIG. 5 illustrates a method for streaming data from a first datacenter to a second datacenter, according to an example;

FIG. 6 illustrates a method for streaming data from a first datacenter to a second datacenter, according to an example; and

FIG. 7 illustrates a system environment implementing a non-transitory computer readable medium for streaming data from a first datacenter to a second datacenter, according to an example.

### DETAILED DESCRIPTION

Stream-processing platforms, such as “Apache Kafka”, “Apache Storm”, etc. enable transfer of data streams between datacenters. A stream-processing platform may be deployed on a single server or on a cluster of multiple servers. The cluster of servers may span across multiple datacenters.

A producer application may write a data stream to the stream-processing platform over a Local Area Network (LAN). The producer application includes processes that can generate data streams and publish the data streams to the stream-processing platform. A consumer application may fetch the data stream from the stream-processing platform. The consumer application includes processes that can request, fetch and acquire data streams from the stream-processing platform.

The producer and consumer applications may interact with the stream-processing platform using Application Programming Interfaces (APIs). The producer applications may interact with the stream-processing platform using Producer APIs and the consumer applications may interact with the stream-processing platform using Consumer APIs. The stream-processing platform may also use Streams APIs for transforming input data streams to output data streams. The producer and consumer applications, their respective APIs, the Streams API, and other APIs used for functioning of the stream-processing platform may constitute an application layer of the stream-processing platform. The stream-processing platform may include a storage layer which is a scalable publish-subscribe message queue architected as a distributed transaction log. The storage layer includes a filesystem that stores data streams in files as records.

Consider that a data stream is to be transferred from a source datacenter, also referred to as a source, to a target datacenter, also referred to as a target. The cluster on which the stream-processing platform is deployed may be distributed across the source and the target. A producer application running at the source may write the data stream to the stream-processing platform. The data stream received by the stream-processing platform from the producer application may be stored and persisted in a filesystem of the stream-processing platform.

A consumer application running at the target may connect to the stream-processing platform over a network, such as a Wide Area Network (WAN) or the Internet to request, fetch and read the data stream from the filesystem of the stream-processing platform. Thus, the requested data stream may be transferred over the network to the consumer application.

In the above-explained scheme of data streaming, the producer and consumer applications, interacting with the stream-processing platform may exchange different request or status messages with the stream-processing platform. The request or status messages include request messages sent by the consumer applications to fetch the data stream from the stream-processing platform, status messages exchanged between the producer and/or consumer applications and the stream-processing platform to keep data transfer protocol alive, and status messages to capture states of different interacting entities, such as servers hosting the stream-processing platform and the producer and consumer applications. Such request or status messages are transferred over the WAN in addition to the actual data stream. This may result in additional bandwidth consumption of the WAN. Also, when multiple consumer applications try to access a single data stream from the stream-processing platform at the source, the single data stream is streamed multiple times over the WAN from the stream-processing platform to the multiple consumer applications at the target, thereby resulting in higher bandwidth consumption of the WAN.

In the present subject matter, transfer of the data streams takes place at the storage layer of the stream-processing platforms instead of the data streams being transported as payload in the application layer. Thus, exchange of status or request messages between the producer applications, consumer applications, and the stream-processing platform may be reduced, thereby reducing WAN bandwidth consumption. Also, since the transfer of the data stream takes place at the storage layer, different aspects of data management, such as data security, data backup, and networking may be implemented in a simpler and easier manner.

Example implementations of the present subject matter for data streaming from a first datacenter or source datacenter (source) to a second datacenter or target datacenter (target) are described. In an example, a data stream received from a stream producer at the source is stored in a first filesystem of a first stream-processing platform implemented at the source. The stream producer includes processes and applications which can generate a data stream and publish the data stream in the stream-processing platform.

Transfer of data associated with the data stream from the first filesystem to a second filesystem of a second stream-processing platform implemented in the target is scheduled at a specific time interval. In an example, the transfer is scheduled in response to completion of a synchronization event at the first filesystem. The synchronization event may be indicative of data being committed to a persistent storage managed by the first filesystem, such that data in the persistent storage is synchronized with the data written by the stream producers at the source. In an example, the synchronization event corresponds to transfer of data stored in filesystem buffers of the first stream-processing platform to the first filesystem.

A delta data from the first filesystem may be replicated to the second filesystem based on the scheduled transfer. The delta data is indicative of modified data of the data stream stored in the first filesystem during the specific time interval. In an example, once the delta data is replicated at the second filesystem, the second stream processing platform may be notified, which can then provide the delta data for being consumed by stream consumers at the target. A stream consumer includes processes and applications that can process data streams received from stream-processing platforms.

With the present subject matter, the data streams are replicated from the first filesystem of the first stream-processing platform at the source to the second filesystem of the second stream-processing platform at the target and thus data is transferred through the storage layer of the stream-processing platform(s). This is in contrast to the scheme of data streaming where, the consumer applications access the data streams directly from the stream-processing platform at the source over the WAN, thereby resulting in exchange of different request or status messages between the stream-processing platform at the source and the consumer applications. With the present subject matter, since the data streams are transferred at the storage layer, the exchange of different request or status messages between the stream-processing platform at the source and the consumer applications at the target may be reduced, thereby reducing WAN bandwidth consumption. Further, in an example, since the replication occurs upon completion of the synchronization event at the first filesystem, application consistency in the replicated data streams is maintained. The application consistency in streaming data ensures that the order of events in the input data stream (as received from the stream producers) is preserved in the output data stream (as provided to the stream consumers).

Also, in the present subject matter, the data associated with the data stream gets stored in the second filesystem of the second stream-processing platform at the target. Thus, the stream consumers at the target can access the data stream from a local server hosting the second stream-processing platform at the target instead of fetching the data stream from a remote server at the source. This may further reduce WAN bandwidth consumption.

Further, if the same data stream is requested by multiple stream consumers, the multiple stream consumers can fetch the data stream from the second filesystem locally available at the target. Thus, multiple requests from multiple stream consumers for reading the same data stream from the remote source is not transferred over the WAN. Further, since the data is streamed using the storage layer, in-built de-duplication at the storage layer and WAN efficient transfer mechanisms can be implemented to ensure that the same data stream does not get transferred multiple times over the WAN. Hence, the bandwidth consumption of the WAN is reduced.

Further, with the present subject matter, direct replication of data from the first filesystem at the source to the second filesystem at the target enables deploying separate clusters of the stream-processing platform at the source and the target. Therefore, cross-datacenter clusters of multiple servers running the stream-processing platform, where the cross-datacenter clusters span across the source and the target, may be eliminated. Thus, complex resource requirements for deploying the cross-datacenter clusters may also be eliminated.

Further, with the present subject matter, since transfer of data associated with the data streams through the storage layer is scheduled at a specific interval, the data streams may get accumulated at the first filesystem, before being replicated to the second filesystem. In an example, the data streams may be accumulated by varying the specific time interval at which transfer of data from the first filesystem to the second filesystem is scheduled. This enables the accumulated data streams at the first filesystem to be processed, for example, it may be deduplicated and/or compressed as per data processing techniques in-built in the first-stream processing platform and supported by the first filesystem. This compression and de-duplication of the data stream is performed by the storage layer on the accumulated data before the data steam is transferred to the target across the WAN. The compression and de-duplication performed by the storage layer is in addition to any compression performed by the stream-processing platform(s) for the payload in the application layer. Thus, data processing capabilities of the storage layer of the first stream-processing platform may also be utilized for handling the accumulated data before the data is replicated at the target.

The stream-processing platform(s) generally perform different data processing operations, such as transformation, filtration, and reduction of data streams, on the data streams which originate from the stream producers and are to be provided to the stream consumers. These data processing operations at the stream-processing platform(s) may provide the data streams to applications at the target in processed forms, such as transformed, filtered, or reduced forms. The data in the processed forms is manageable and can be utilized by applications at the target to generate meaningful information. With the present subject matter, since data is streamed through the stream processing platform(s) using its storage layer, the applications and APIs of the application layer of the stream processing platform(s) remain intact. Hence, capability of the first and second stream-processing platform(s) (and associated applications) to perform the data processing operations remain unchanged. Thus, with the present subject matter, data streams in one or more of the processed forms may be selectively replicated, at the specific time intervals, from the first filesystem at the source to the second filesystem at the target, depending on different applications running at the stream consumers. This enables utilization of the data processing capabilities of the stream-processing platform(s) while the data is streamed through the storage layer.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

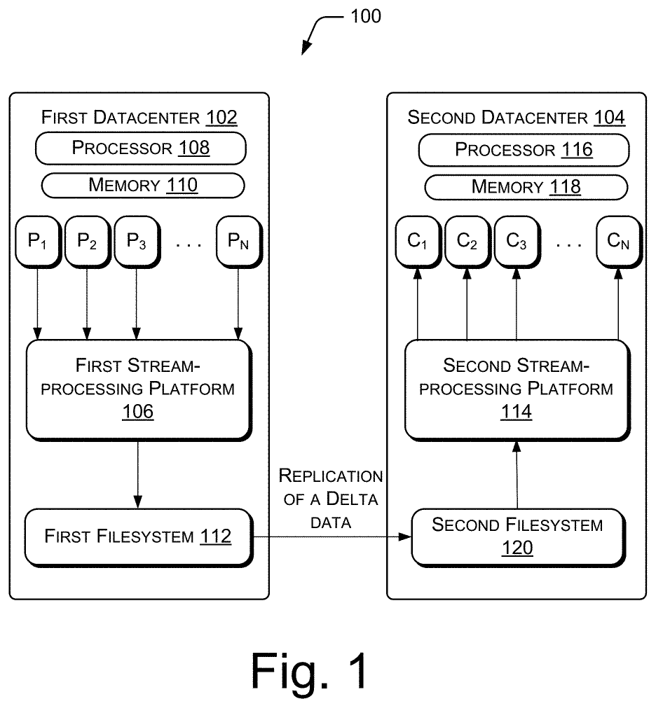

FIG. 1 illustrates a network environment 100 where a first datacenter 102 streams data to a second datacenter 104, according to an example. The network environment 100 includes the first datacenter 102 and the second datacenter 104. The first datacenter 102 may be a source datacenter also referred to as a source 102 and the second datacenter 104 may be a target datacenter also referred to as a target 104. In an example, the source 102 may be an edge device, such as an edge server, an intelligent edge gateway, etc., and the target 104 may be a core computing system where deep analytics of data may be performed. The source 102 and the target 104 may communicate over a network, such as a Wide Area Network (WAN).

A first stream-processing platform 106 may be implemented or deployed in the source 102. In an example, the first stream-processing platform 106 may run on a server (not shown) at the source 102. The source 102 includes a processor 108 and a memory 110 coupled to the processor 108. The memory 110 stores instructions executable by the processor 108.

The first stream-processing platform 106 running at the source 102 may receive data streams from stream producers P₁, P₂, P₃, . . . , P_{N}, also referred as stream producer(s) P. A stream producer P may be a process or application that can generate a data stream and send the data stream to the first stream-processing platform 106. A data stream refers to a continuous flow of data bits for a particular time interval called a streaming interval. The stream producer P may send the data stream to the first stream-processing platform 106 over a Local Area Network (LAN).

The first stream-processing platform 106 may store and persist the data stream received from the stream producer P in a first filesystem 112. The first filesystem 112 stores and organizes data streams processed by the first stream-processing platform 106. The first filesystem 112 may control how data streams are stored in and retrieved from a storage of the source 102. The storage may be a Direct-attached-storage (DAS), a network-attached storage (NAS), or the memory 110.

A second stream-processing platform 114 may be implemented or deployed at the target 104. In an example, the second stream-processing platform 114 may be a replica of the first stream-processing platform 106. In an example, the second stream-processing platform 114 may run on a server (not shown) in the target 104. The target 104 includes a processor 116 and a memory 118 coupled to the processor 116. The memory 118 stores instructions executable by the processor 116.

The second stream-processing platform 114 running at the target 104 may serve data streams to stream consumers C₁, C₂, C₃, . . . , C_{N}, also referred as stream consumer(s) C. A stream consumer C may be a process or application that can read and process a data stream from the second stream-processing platform 114. Data streams processed by the second stream-processing platform 114 may be stored and organized in a second filesystem 120. The second filesystem 120 may control how the data streams are stored in and retrieved from a storage of the target 104. The storage may be a Direct-attached-storage (DAS), a network-attached storage (NAS), or the memory 118.

In an example, a stream producer P may generate a data stream and publish the data stream at the first stream-processing platform 106. The first stream-processing platform 106 may receive the data stream from the stream producer P. The processor 108 at the source 102 may store the data stream in the first filesystem 112. In an example, the first filesystem 112 stores the data streams as records within files. A file in the first filesystem 112 is thus a collection of records.

The processor 108 may schedule transfer of data associated with the data stream from the first filesystem 112 to the second filesystem 120 at a specific time interval. In an example, the specific time interval is a time interval between two successive synchronization events at the first filesystem 112. A synchronization event corresponds to transfer of data stored in filesystem buffers of the first stream-processing platform 106 to the first filesystem 112.

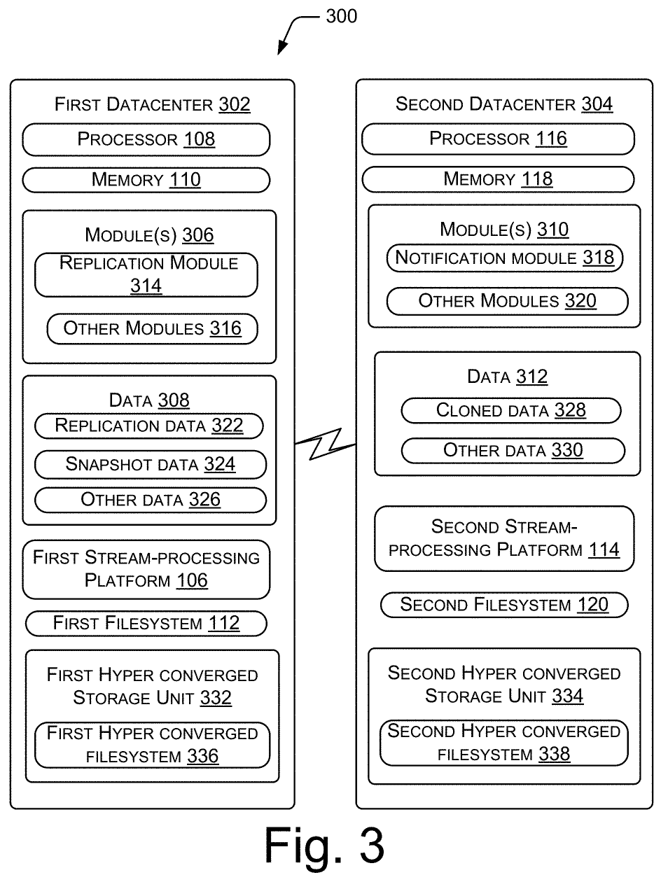

The processor 108 may replicate a delta data from the first filesystem 112 to the second filesystem 120 based on the scheduled data transfer at the specific time intervals. The replication of the delta data may be performed using various techniques described later with reference to FIG. 3. The delta data is indicative of modified data of the data stream stored in the first filesystem 112 during the specific time interval. Thus, modifications to the data stream at the synchronization events are captured in the delta data that is transferred to the second filesystem 120 at the target 104. The delta data replicated to the second filesystem 120 is readable and can be consumed by the stream consumers C. Thus, entire data streams or portions thereof are transferred form the source 102 to the target 104 through replication at the storage layer.

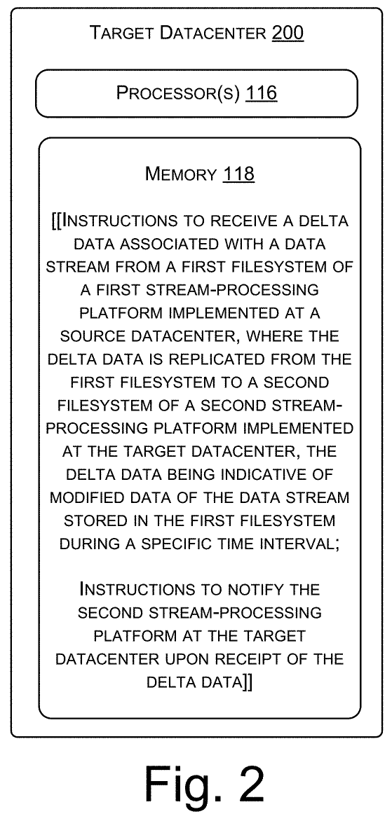

FIG. 2 illustrates a target datacenter 200 according to an example of the present subject matter. A stream-processing platform, such as the second stream-processing platform 114 may be deployed at the target datacenter 200 also referred to as the target 200. The target 200 may receive data streams from a source, such as the source 102.

The target 200 includes a processor 116 and a memory 118 coupled to the processor 116. The memory 118 stores instructions executable by the processor 116. The instructions when executed by the processor 116 cause the processor 116 to receive a delta data associated with a data stream from a first filesystem of a first stream-processing platform, such as the first filesystem 112 of the first stream-processing platform 106, implemented at a source datacenter, such as the source datacenter 102. The delta data is replicated from the first filesystem to a second filesystem of a second stream-processing platform, such as the second filesystem 120 of the second stream-processing platform 114, implemented at a target datacenter, such as the target datacenter 104. The delta data is indicative of modified data of the data stream stored in the first filesystem during a specific time interval. In an example, the specific time interval may be the time interval between two synchronization events at the first filesystem.

Further, the instructions when executed by the processor 116 cause the processor 116 to notify the second stream-processing platform at the target datacenter, upon receipt of the delta data. In an example, to notify the second stream-processing platform upon receipt of the delta data, the second stream-processing platform deployed at the target datacenter 200 may be restarted. Aspects described with respect to FIGS. 1 and 2 are further described in detail with respect to FIG. 3.

FIG. 3 illustrates a network environment 300 where a first datacenter 302 streams data to a second datacenter 304, according to an example of the present subject matter. The first datacenter 302 or source datacenter 302 and the second datacenter 304 or target datacenter 304 are disposed in the network environment 300. The source datacenter 302 also referred to as source 302 may be similar to the source 102 in many respects and the target datacenter 304 also referred to as the target 304 may be similar to the target 104 or 200 in many respects. A first stream-processing platform 106 may be deployed at the source 302 and a second stream-processing platform 114 may be deployed at the target 304. The source 302 and the target 304 may communicate over the WAN or the internet.

The source 302 includes a processor 108 coupled to a memory 110. The target 304 includes a processor 116 coupled to a memory 118. The processor(s) 108 and 116 may be implemented as microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions stored in the memory 110. The processor 116 is configured to fetch and execute computer-readable instructions stored in the memory 118.

The functions of the various elements shown in the FIG. 3, including any functional blocks labeled as “processor(s)”, may be provided through the use of dedicated hardware as well as hardware capable of executing software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

The memory 110 and 118 may include any computer-readable medium known in the art including, for example, volatile memory (e.g., RAM), and/or non-volatile memory (e.g., EPROM, flash memory, etc.). Modules 306 and data 308 may reside in the memory 110. Modules 310 and data 312 may reside in the memory 118. The modules 306 and 310 can be implemented as instructions stored on a computer readable medium and executable by a processor and/or as hardware. The modules 306 and 310 include routines, programs, components, data structures, and the like, which perform particular tasks or implement particular abstract data types.

The modules 306 include a replication module 314 which corresponds to instructions stored on a computer readable medium and executable by a processor to replicate a delta data from the first filesystem 112 to the second filesystem 120. The modules 306 also comprise other modules 316 that supplement applications on the source 302, for example, modules of an operating system.

The modules 310 include a notification module 318 which corresponds to instructions stored on a computer readable medium and executable by a processor to notify the stream-processing platform 114 upon receipt of a delta data at the second filesystem 120. The modules 310 also include other modules 320 that supplement applications on the target 304, for example, modules of an operating system.

The data 308 serves, amongst other things, as a repository for storing data that may be fetched, processed, received, or generated by the modules 306. The data 308 includes replication data 322 which stores data to be replicated to the target 304 and snapshot data 324 which stores snapshots of the first filesystem 112. The data 308 also comprises other data 326 corresponding to the other modules 316.

The data 312 serves, amongst other things, as a repository for storing data that may be fetched, processed, received, or generated by the modules 310. The data 312 includes cloned data 328 which includes a cloned copy of data replicated from the source 302. The data 312 comprises other data 330 corresponding to the other modules 320.

The source 302 includes a first hyper converged storage unit 332 and the target 304 includes a second hyper converged storage unit 334. The hyper converged storage units 332 and 334 may include virtualized computing elements, such as a hypervisor which can create and run Virtual machines (VMs), a software-defined storage, and/or a software-defined network. In some implementations, each VM's data on a hyper converged storage unit may be organized into a separate per-VM directory managed by the hyper converged filesystem of that hyper converged storage unit. The hyper converged filesystem may split VM data (e.g., files) into objects, such as objects of 8 KiB size, and persist the objects to disk in an object store that deduplicates objects across all VMs of that hyper converged storage unit. Objects may be identified by an object signature, such as an object's hash (e.g., SHA-1 hash or the like). VM directories may include objects and metadata of objects organized in a hash tree or Merkle tree. In some examples, one or more directories of VM data (and associated objects) may be mirrored between the first hyper converged unit 332 and the second hyper converged unit 334.

Although in FIG. 3, the module(s), the data, the first and second stream processing platform(s), and the first and second filesystems are shown outside the first and second hyper converged storage unit(s), in some examples, the modules, the data, and the stream-processing platform(s) may reside within the first and second hyper converged storage unit(s). For example, one or more of the module(s) 306, the data 308, the first stream-processing platform 106, and the first filesystem 112 may reside within the first hyper converged storage unit 332. In another example, one or more of the module(s) 310, the data 312, the second stream-processing platform 114, and the second filesystem 120 may reside within the second hyper converged storage unit 334.

In operation, a stream producer, such as the stream producer P, may write a data stream to the first stream-processing platform 106. The processor 108 may execute instructions stored in the memory 110 to store the data stream received from the stream producer P in the first filesystem 112 of the first stream-processing platform 106. In an example, data is written to the first filesystem 112 on completion of a synchronization event at the first filesystem 112. The synchronization event corresponds to transfer of data stored in filesystem buffers of the first stream-processing platform 106 to the first filesystem 112. In an example, for a stream-processing platform, such as Apache Kafka, the synchronization event may be a FSYNC system call which may occur at a pre-defined time interval, such as a flush interval.

The replication module 314 may intercept the synchronization event to initiate replication of data associated with the data stream. Thus, the replication module 314 may schedule transfer of the data associated with the data stream from the first filesystem 112 to the second filesystem 120 in response to completion of the synchronization event. The transfer is scheduled at a specific time interval. The specific time interval is a time interval between two successive synchronization events at the first filesystem 112. In an example, the specific time interval may be the flush interval or a time interval between any two FSYNC system calls at the first filesystem 112.

On completion of the synchronization event, the replication module 314 may determine a delta data. The delta data is indicative of modified data of the data stream stored in the first filesystem 112 during the specific time interval. In an example, the delta data also captures data written to the first filesystem 112 during the synchronization event. The replication module 314 may replicate the delta data from the first filesystem 112 to the second filesystem 120. In an example, the replication module 314 may use a replication utility, such as a RSYNC utility, to transfer the delta data from the first filesystem 112 to the second filesystem 120. The RSYNC utility may determine the delta data and replicate the same at the second filesystem 120 at the target 304. The delta data replicated to the second filesystem 120 is readable by stream consumers, such as the stream consumers C, at the target 304.

The description hereinafter elaborates other example implementations of data streaming from the source 302 to the target 304 through the storage layer of the first and second stream-processing platforms 106 and 114.

In an example, the replication module 314 may associate the first stream-processing platform 106 with a first hyper converged storage unit 332 maintained in the source 302. In an example, the first hyper converged storage unit 332 may be deployed in a cluster spanning across different geographical sites. By associating the first stream-processing platform 106 with the first hyper converged storage unit 332, data stored in the first filesystem 112 may be organized in the first hyper converged filesystem 336 of the first hyper converged storage unit 332. In an example, once the first stream-processing platform 106 is associated with the first hyper converged storage unit 332, the first hyper converged storage unit 332 may expose its datastore, such as an NFS datastore, to the first stream-processing platform 106. This allows the first stream-processing platform 106 to use the first hyper converged filesystem 336 for storing data streams.

In an example, instructions stored in the memory 118 and executable by the processor 116 may associate the second stream-processing platform 114 with a second hyper converged storage unit 334 maintained in the target 304. By associating the second stream-processing platform 114 with the second hyper converged storage unit 334, data stored in the second filesystem 120 may be organized in the second hyper converged filesystem 338 of the second hyper converged storage unit 334. In an example, once the second stream-processing platform 114 is associated with the second hyper converged storage unit 334, the second hyper converged storage unit 334 may expose its datastore, such as an NFS datastore, to the second stream-processing platform 114. This allows the second stream-processing platform 114 to use the second hyper converged filesystem 338 for storing data streams and accessing data streams stored in the second hyper converged filesystem 338.

In an example, a stream producer, such as the stream producer P, may write a data stream to the first stream-processing platform 106. The processor 108 may execute instructions stored in the memory 110 to store the data stream received from the stream producer P in the first filesystem 112 of the first stream-processing platform 106. In an example, data is written to the first filesystem 106 on completion of a synchronization event at the first filesystem 106.

In response to the synchronization event occurring at the first filesystem 112, a data write event may occur at the first hyper converged filesystem 336. In an example, the first stream-processing platform 106 may be “Apache Kafka”. In the example, the synchronization event may be an FSYNC system call and the data write event may be a Network File System (NFS) commit command. On occurrence of the FSYNC system call at the filesystem of the “Apache Kafka”, a Network File System (NFS) commit command may be received by the first hyper converged filesystem 336. Thus, in an example, the data write event corresponds to a commit command, such as an NFS commit command received by the first hyper converged filesystem 336.

The replication module 314 may intercept the commit command to initiate replication of data from the source 302 to the target 304. The replication module 314 may schedule replication to take place upon execution of the commit command at the first hyper converged filesystem 336. Thus, the specific time interval at which replication is scheduled to occur is a time interval between two successive data write events at the first hyper converged filesystem 336. Since, the replication is initiated on completion of data write events at the first hyper converged filesystem 336, the data streams get replicated in an application consistent manner, so that applications, such as the stream consumers, consuming the data streams receive complete data streams for processing without any data value being dropped.

In response to completion of a current data write event at the first hyper converged filesystem 336, the replication module 314 may capture a current snapshot of the first hyper converged filesystem 336. In an example, the current data write event refers to the most recent data write event or commit command received by the first hyper converged filesystem 336. The current snapshot is indicative of a current state of the first hyper converged filesystem 336 on completion of the current data write event. In an example, the current snapshot includes a snapshotted object tree of the first hyper converged filesystem 336.

The replication module 314 may compare a first set of signatures of the current snapshot with a second set of signatures of a previous replicated snapshot. The previous replicated snapshot is indicative of a past state of the first hyper converged filesystem 336 at a time instance when mirroring of the first hyper converged filesystem 336 was previously performed. Mirroring of the first hyper converged filesystem 336 refers to creating a replica of one or more directories of VM data (and associated objects) between the first hyper converged filesystem 336 and the second hyper converged filesystem 338. The first set of signatures is based on hash digests, such as SHA-1 digests of data associated with the current snapshot and the second set of signatures is based on hash digests, such as SHA-1 digests, of data associated with the previous replicated snapshot.

Based on the comparison, the replication module 314 may determine a delta snapshot. The delta snapshot corresponds to the delta data and includes a snapshotted view of data streams written to the hyper converged filesystem 336 between two successive data write events. In an example, when the first hyper converged filesystem 336 is mirrored to the second hyper converged filesystem 338 for the first time, the current snapshot is identified as the delta snapshot.

Upon determining the delta snapshot, the replication module 314 may replicate the delta snapshot to the second hyper converged filesystem 338. In an example, the delta snapshot may be replicated by using asynchronous mirroring techniques supported by the first and second hyper converged filesystems 336 and 338. Once the delta snapshot is replicated at the second hyper converged filesystem 338, the current snapshot is set as the previous replicated snapshot to be utilized for future replication operations.

According to another example implementation, the replication is scheduled at pre-defined time intervals. In this example implementation, application consistency of the data streams is maintained by in-built consistency mechanisms of the stream-processing platform(s).

In an example, a stream producer, such as the stream producer P, may write a data stream to the first stream-processing platform 106. The processor 108 may execute instructions stored in the memory 110 to store the data stream received from the stream producer P in the first filesystem 112 of the first stream-processing platform 106. Since, the stream-processing platform 106 is associated with the first hyper converged storage unit 332, data streams stored in the first filesystem 112 get organized in the first hyper converged filesystem 336.

The replication module 314 may schedule replication of data from the first hyper converged filesystem 336 to the second hyper converged filesystem 338 at a pre-defined time interval. Based on the pre-defined time interval, the replication module 314 may capture a current snapshot of the first hyper converged filesystem 336 at a time instance. The current snapshot is indicative of a current state of the first hyper converged filesystem 336 at the time instance when the current snapshot is captured.

The replication module 314 may compare a first set of signatures of the current snapshot with a second set of signatures of a previous replicated snapshot. The previous replicated snapshot is indicative of a past state of the first hyper converged filesystem 336 at a time instance when mirroring of the first hyper converged filesystem 336 was previously performed. Mirroring of the first hyper converged filesystem 336 refers to creating a replica of one or more directories of VM data (and associated objects) between the first hyper converged filesystem 336 and the second hyper converged filesystem 338. The first set of signatures is based on hash digests, such as SHA-1 digests of data associated with the current snapshot and the second set of signatures is based on hash digests, such as SHA-1 digests of data associated with the previous replicated snapshot.

Based on the comparison, the replication module 314 may determine a delta snapshot. The delta snapshot corresponds to the delta data and includes a snapshotted view of data streams written to the hyper converged filesystem 336 during the pre-defined time interval. In an example, when the first hyper converged filesystem 336 is mirrored to the second hyper converged filesystem 338 for the first time, the current snapshot is identified as the delta snapshot.

Upon determining the delta snapshot, the replication module 314 may replicate the delta snapshot to the second hyper converged filesystem 338. In an example, the delta snapshot may be replicated by using asynchronous mirroring techniques supported by the first and second hyper converged filesystems 336 and 338. Once the delta snapshot is replicated at the second hyper converged filesystem 338, the current snapshot is set as the previous replicated snapshot to be utilized for future replication operations.

In the example implementation, where the replication is scheduled at the pre-defined time interval, application consistency of the data streams may be checked by in-built checksum mechanisms of the first and second stream-processing platforms 106 and 114. In an example, the in-built checksum mechanisms include Cyclic Redundancy Check (CRC) 32 checksum. If the data stream at the target 304 is identified to be inconsistent, then the data stream may again be replicated from the source 302 to the target 304.

In response to the delta snapshot being replicated at the second hyper converged filesystem 338, the other modules 320 may create a cloned copy of the delta snapshot. The notification module 318 may promote the cloned copy as a working copy of the data stream. The cloned copy of the delta snapshot may be stored in the second filesystem 120. The notification module 318 then notifies the second stream-processing platform 114 at the target 304 that the delta snapshot and the corresponding delta data has been replicated at the second filesystem 120. In an example, the notification module 318 may restart the second stream-processing platform 114. Once the second stream-processing platform 114 is restarted, the second stream-processing platform 114 may reevaluate an offset of the records in the file stored in the second filesystem 120. In an example, the notification module 318 may reevaluate the high water mark of the records.

Once the second stream-processing platform 114 is notified that the replicated delta data is stored at the second filesystem 120, the notification module 318 may provide the delta data for being accessed by stream consumers, such as the stream consumers C, at the target datacenter 304. In an example, based on the reevaluation of the high-water mark of the records, the second stream-processing platform 114 may serve the delta data or newly added records to the stream consumers. Thus, the stream consumers may communicate over LAN with the second stream-processing platform 114 to read the delta data from the second filesystem 120. In this manner data streams or portions thereof are streamed from the stream producers at the source 302 to the stream consumers at the target 304 without the stream consumers polling the first stream-processing platform 106 over WAN. The data streams are transferred through asynchronous replication from the first filesystem 112 to the second filesystem 120 in an application consistent manner.

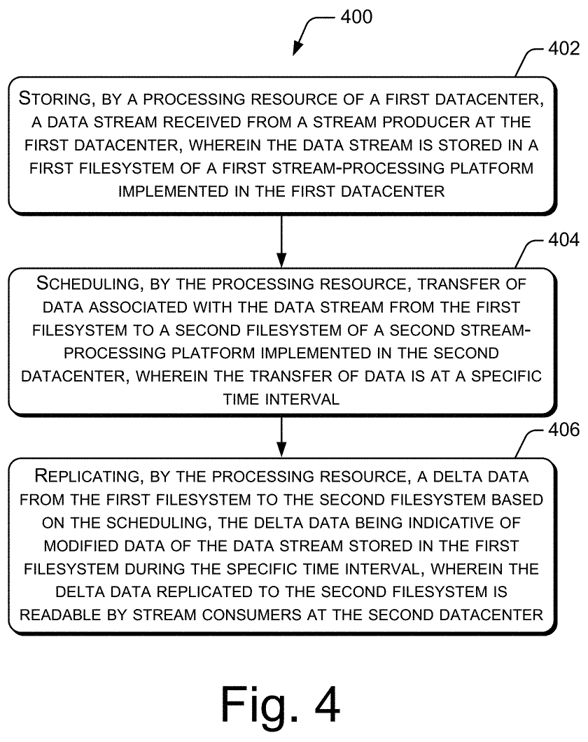

FIG. 4 illustrates a method 400 for streaming data from a first datacenter to a second datacenter, according to an example. The method 400 can be implemented by processing resource(s) or computing device(s) through any suitable hardware, a non-transitory machine readable medium, or combination thereof. In an example, the method 400 may be performed by a replication module, such as the replication module 314 which includes instructions stored on a medium and executable by a processing resource, such as the processor 108, of a source datacenter, such as the source datacenter 102 or 302. Further, although the method 400 is described in context of the aforementioned source datacenter 102 or 302, other suitable systems may be used for execution of the method 400. It may be understood that processes involved in the method 400 can be executed based on instructions stored in a non-transitory computer readable medium. The non-transitory computer readable medium may include, for example, digital memories, magnetic storage media, such as a magnetic disks and magnetic tapes, hard drives, or optically readable digital data storage media.

Referring to FIG. 4, at block 402, a data stream received from a stream producer at a first datacenter is stored in a first filesystem of a first stream-processing platform implemented in the first datacenter. The stream producer may be similar to a stream producer P. The first filesystem of the first stream-processing platform may be similar to the first filesystem 112 of the first stream-processing platform 106. The first datacenter may be similar to the first datacenter 102 or 302.

At block 404, transfer of data associated with the data stream from the first filesystem to a second filesystem of a second stream-processing platform implemented in the second datacenter is scheduled. The second filesystem of the second stream-processing platform may be similar to the second filesystem 120 of the second stream-processing platform 114. The second datacenter may be similar to the second datacenter 104 or 304. The transfer of data is at a specific time interval. In an example, the specific time interval is a time interval between two successive synchronization events at the first filesystem. In an example, the transfer of data associated with the data stream is scheduled in response to completion of a synchronization event at the first filesystem. The synchronization event corresponds to transfer of data stored in filesystem buffers of the first stream-processing platform to the first filesystem.

At block 406, a delta data may be replicated from the first filesystem to the second filesystem based on the scheduled transfer. The delta data is indicative of modified data of the data stream stored in the first filesystem during the specific time interval. In an example, the delta data may be replicated through a replication utility, such as RSYNC, to transfer the delta data from the first filesystem to the second filesystem. Once the delta data is replicated to the second filesystem, the delta data is readable by stream consumers, such as the stream consumers C, at the second datacenter, such as the second datacenter 104 or 304.

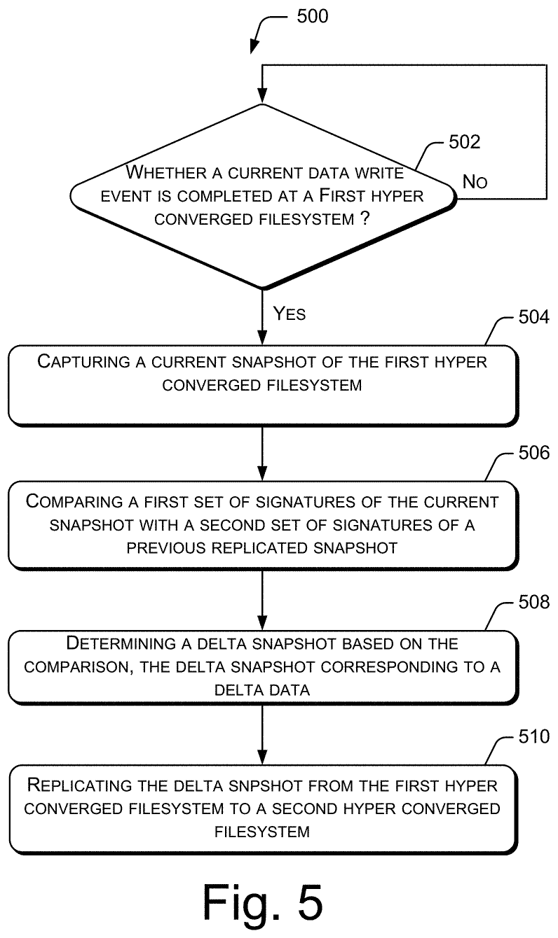

FIG. 5 illustrates a method 500 for data streaming from a first datacenter to a second datacenter, according to an example. In an example, steps of the method 500 may be performed by a replication module, such as the replication module 314.

In an example, in the method 500, the processing resource may associate the first stream-processing platform, such as the first stream-processing platform 106, with a first hyper converged storage unit, such as the first hyper converged storage unit 332 maintained in the first datacenter, such as the first datacenter 302. By associating the first stream-processing platform with the first hyper converged storage unit, data stored in the first filesystem is organized in a first hyper converged filesystem of the first hyper converged storage unit.

At block 502, it is checked whether a current data write event is completed at the first hyper converged filesystem. In an example, the current data write event may be an NFS commit command received at the first hyper converged filesystem.

In response to completion of the current data write event at the first hyper converged filesystem (‘Yes’ branch from block 502), a current snapshot of the first hyper converged filesystem is captured, at block 504. The current snapshot indicative of a current state of the first hyper converged filesystem on completion of the current data write event. If there is no data write event occurring at the first hyper converged filesystem (‘No’ branch from block 502), the method 500 again checks for occurrence and completion of the current data write event.

At block 506, a first set of signatures of the current snapshot is compared with a second set of signatures of a previous replicated snapshot. The previous replicated snapshot is indicative of a past state of the first hyper converged filesystem at a time instance when mirroring of the first hyper converged filesystem was previously performed. In some implementations, the first set of signatures is based on hash digests of data associated with the current snapshot and the second set of signatures is based on hash digests of data associated with the previous replicated snapshot.

At block 508, a delta snapshot corresponding to a delta data may be determined based on the comparison. The delta data indicates the modified data of the data stream during the data write event at the first hyper converged filesystem. At block 510, the delta snapshot may be replicated from the first hyper converged filesystem to a second hyper converged filesystem, such as the second hyper converged filesystem 338, at the target. The delta snapshot may be replicated based on asynchronous mirroring techniques supported by the hyper converged filesystems.

Once the delta snapshot is replicated the second hyper converged filesystem at the target, the second stream-processing platform may provide the delta snapshot for being accessed by stream consumers at the target.

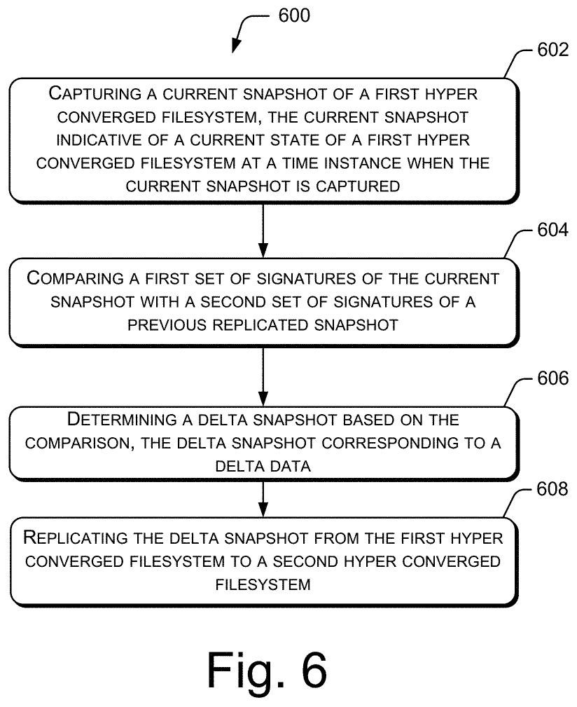

FIG. 6 illustrates a method 600 for streaming data from a first datacenter to a second datacenter, according to an example. The method 600 can be implemented by processing resource(s) or computing device(s) through any suitable hardware, instructions stored in a non-transitory machine readable medium, or combination thereof. It may be understood that processes involved in the method 600 can be executed based on instructions stored in a non-transitory computer readable medium. The non-transitory computer readable medium may include, for example, digital memories, magnetic storage media, such as a magnetic disks and magnetic tapes, hard drives, or optically readable digital data storage media. In an example, steps of the method 600 may be performed by a replication module, such as the replication module 314.

At block 602, a current snapshot of the first hyper converged filesystem is captured. The current snapshot is indicative of a current state of the first hyper converged filesystem at a time instance when the current snapshot is captured. The current snapshot is captured at pre-defined time intervals.

At block 604, a first set of signatures of the current snapshot is compared with a second set of signatures of a previous replicated snapshot. The previous replicated snapshot is indicative of a past state of the first hyper converged filesystem at a time instance when mirroring of the first hyper converged filesystem was previously performed. The first set of signatures is based on hash digests of data associated with the first snapshot and the second set of signatures is based on hash digests of data associated with the second snapshot.

At block 606, a delta snapshot corresponding to a delta data is determined based on the comparison. The delta data is indicative of modified data of the data stream in the first filesystem, such as the first filesystem 112, during the pre-defined time interval.

At block 608, the delta snapshot may be replicated from the first hyper converged filesystem to a second hyper converged filesystem in the target, such as the target 304, thereby enabling transfer of the delta data to the second hyper converged filesystem. Once the delta snapshot is replicated the second hyper converged filesystem at the target, the second stream-processing platform may provide the delta data for being accessed by stream consumers at the target.

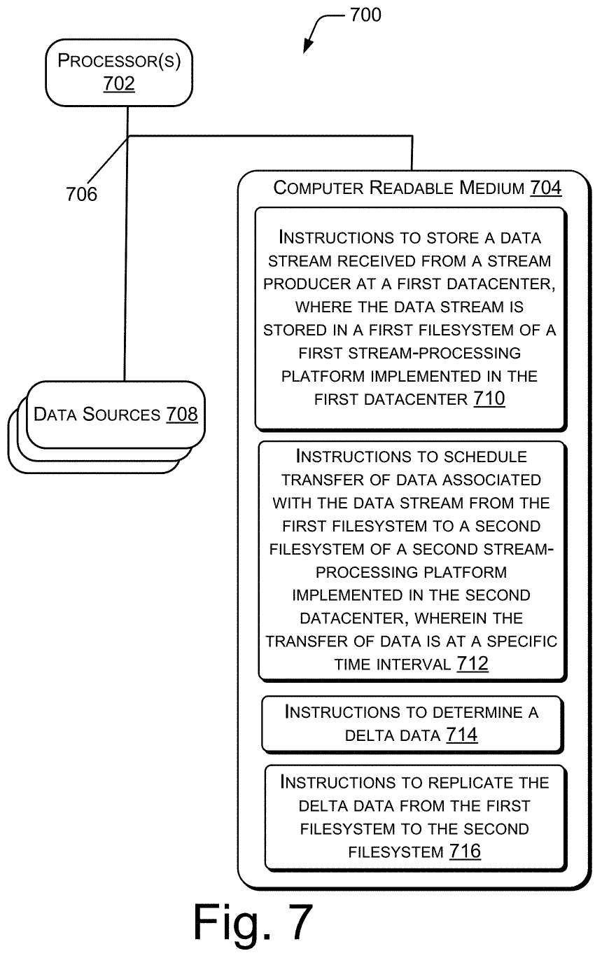

FIG. 7 illustrates a system environment 700 implementing a non-transitory computer readable medium for streaming data from a first datacenter to a second datacenter, according to an example.

In an example, the system environment 700 includes processor(s) 702 communicatively coupled to a non-transitory computer readable medium 704 through a communication link 706. In an example implementation, the system environment 700 may be a computing system, such as the first datacenter 102 or 302. In an example, the processor(s) 702 may have one or more processing resources for fetching and executing computer-readable instructions from the non-transitory computer readable medium 704.

The non-transitory computer readable medium 704 can be, for example, an internal memory device or an external memory device. In an example implementation, the communication link 706 may be a direct communication link, such as any memory read/write interface.

The processor(s) 702 and the non-transitory computer readable medium 704 may also be communicatively coupled to data sources 708 over the network. The data sources 708 can include, for example, memory of the system, such as the first datacenter 102 or 302.

In an example implementation, the non-transitory computer readable medium 704 includes a set of computer readable instructions which can be accessed by the processor(s) 702 through the communication link 706 and subsequently executed to perform acts for data streaming between a first datacenter, such as the first datacenter 102 or 302 and a second datacenter, such as the second datacenter 104 or 304. In an example, the first datacenter may be an edge device and the second datacenter may be a core device in an edge-core network infrastructure.

Referring to FIG. 7, in an example, the non-transitory computer readable medium 704 includes instructions 710 that cause the processor(s) 702 to store a data stream received from a stream producer at the first datacenter. The data stream is stored in a first filesystem of a first stream-processing platform implemented in the first datacenter.

The non-transitory computer readable medium 704 includes instructions 712 that cause the processor(s) 702 to schedule transfer of data associated with the data stream from the first filesystem to a second filesystem of a second stream-processing platform implemented in the second datacenter. The transfer of data is at a specific time interval. In an example, the non-transitory computer readable medium 704 includes instructions that cause the processor(s) 702 to schedule the transfer of data in response to completion of a synchronization event at the first filesystem. The synchronization event corresponds to transfer of data stored in filesystem buffers of the first stream-processing platform to the first filesystem. In an example, the specific time interval is a time interval between two successive synchronization events at the first filesystem.

The non-transitory computer readable medium 704 includes instructions 714 that cause the processor(s) 702 to determine a delta data. The delta data is indicative of modified data of the data stream stored in the first filesystem during the specific time interval. In an example, the delta data may be determined by snapshot-based comparison of the states of the first filesystem.

The non-transitory computer readable medium 704 includes instructions 716 that cause the processor(s) 702 to replicate the delta data from the first filesystem to the second filesystem. The delta data replicated at the second filesystem is readable by stream consumers at the second datacenter or the target. Further, in an example, the non-transitory computer readable medium 704 includes instructions that cause the processor(s) 702 to associate the first stream-processing platform with a first hyper converged storage unit maintained in the first datacenter. Thus, the data stored in the first filesystem gets organized in a first hyper converged filesystem of the hyper converged storage unit.

Although implementations of present subject matter have been described in language specific to structural features and/or methods, it is to be noted that the present subject matter is not necessarily limited to the specific features or methods described. Rather, the specific features and methods are disclosed and explained in the context of a few implementations for the present subject matter.

We claim:

1. A method for streaming data from a first datacenter to a second datacenter, the method comprising:
storing, by a processing resource of the first datacenter, a data stream received from a stream producer at the first datacenter, wherein the data stream is stored in a first filesystem of a first stream-processing platform implemented in the first datacenter;
scheduling, by the processing resource, transfer of data associated with the data stream from the first filesystem to a second filesystem of a second stream-processing platform implemented in the second datacenter, wherein the transfer of data is at a specific time interval; and
replicating, by the processing resource, a delta data from the first filesystem to the second filesystem based on the scheduling, the delta data being indicative of modified data of the data stream stored in the first filesystem during the specific time interval, wherein the delta data replicated to the second filesystem is readable by stream consumers at the second datacenter.

2. The method as claimed in claim 1, wherein the scheduling is in response to completion of a synchronization event at the first filesystem, the synchronization event corresponding to transfer of data stored in filesystem buffers of the first stream-processing platform to the first filesystem.

3. The method as claimed in claim 2, wherein the specific time interval is a time interval between two successive synchronization events at the first filesystem.

4. The method as claimed in claim 1, wherein the delta data is replicated through a replication utility to transfer the delta data from the first filesystem to the second filesystem.

5. The method as claimed in claim 1, wherein the method further comprises associating, by the processing resource, the first stream-processing platform with a first hyper converged storage unit maintained in the first datacenter, wherein data stored in the first filesystem is organized in a first hyper converged filesystem of the first hyper converged storage unit.

6. The method as claimed in claim 5, wherein the specific time interval is a time interval between two successive data write events at the first hyper converged filesystem, wherein the method further comprises:
in response to completion of a current data write event at the first hyper converged filesystem, capturing, by the processing resource, a current snapshot of the first hyper converged filesystem, the current snapshot indicative of a current state of the first hyper converged filesystem on completion of the current data write event;
comparing, by the processing resource, a first set of signatures of the current snapshot with a second set of signatures of a previous replicated snapshot, the previous replicated snapshot indicative of a past state of the first hyper converged filesystem at a time instance when mirroring of the first hyper converged filesystem was previously performed, wherein the first set of signatures is based on hash digests of data associated with the current snapshot and the second set of signatures is based on hash digests of data associated with the previous replicated snapshot; and
determining, by the processing resource, a delta snapshot corresponding to the delta data based on the comparison.

7. The method as claimed in claim 5, wherein the method further comprises:
capturing, by the processing resource, a current snapshot of the first hyper converged filesystem, the current snapshot indicative of a current state of the first hyper converged filesystem at a time instance when the current snapshot is captured;
comparing, by the processing resource, a first set of signatures of the current snapshot with a second set of signatures of a previous replicated snapshot, the previous replicated snapshot indicative of a past state of the first hyper converged filesystem at a time instance when mirroring of the first hyper converged filesystem was previously performed, wherein the first set of signatures is based on hash digests of data associated with the first snapshot and the second set of signatures is based on hash digests of data associated with the second snapshot; and
determining, by the processing resource, a delta snapshot corresponding to the delta data based on the comparison.

8. A target datacenter for receiving data streamed from a source datacenter, the target datacenter comprising:
a processor; and
a memory coupled to the processor, the memory storing instructions executable by the processor to:
receive a delta data associated with a data stream from a first filesystem of a first stream-processing platform implemented at the source datacenter, wherein the delta data is replicated from the first filesystem to a second filesystem of a second stream-processing platform implemented at the target datacenter, the delta data being indicative of modified data of the data stream stored in the first filesystem during a specific time interval; and
notify the second stream-processing platform at the target datacenter upon receipt of the delta data.

9. The target datacenter as claimed in claim 8, wherein to notify the second stream-processing platform, the memory stores instructions executable by the processor to restart the second stream-processing platform.

10. The target datacenter as claimed in claim 8, wherein the memory stores instructions executable by the processor further to provide the delta data for being accessed by stream consumers at the target datacenter, once the second stream-processing platform is notified.

11. The target datacenter as claimed in claim 8, wherein the specific time interval is a time interval between two successive synchronization events at the first filesystem.

12. The target datacenter as claimed in claim 8, wherein the memory stores instructions executable by the processor further to associate the second stream-processing platform with a second hyper converged storage unit maintained in the target datacenter, wherein the delta data replicated to the second filesystem is stored in a second hyper converged filesystem of the second hyper converged storage unit.

13. A non-transitory computer-readable medium comprising computer-readable instructions for streaming data from a first datacenter to a second datacenter, the computer-readable instructions when executed by a processor, cause the processor to:
store a data stream received from a stream producer at the first datacenter, wherein the data stream is stored in a first filesystem of a first stream-processing platform implemented in the first datacenter;
schedule transfer of data associated with the data stream from the first filesystem to a second filesystem of a second stream-processing platform implemented in the second datacenter, wherein the transfer of data is at a specific time interval;
determine a delta data, the delta data indicative of modified data of the data stream stored in the first filesystem during the specific time interval; and
replicate the delta data from the first filesystem to the second filesystem, wherein the delta data replicated at the second filesystem is readable by stream consumers at the second datacenter.

14. The non-transitory computer-readable medium as claimed in claim 13, wherein the transfer of data is scheduled in response to completion of a synchronization event at the first filesystem, the synchronization event corresponding to transfer of data stored in filesystem buffers of the first stream-processing platform to the first filesystem, wherein the specific time interval is a time interval between two successive synchronization events at the first filesystem.

15. The non-transitory computer-readable medium as claimed in claim 13, wherein the instructions, when executed by the processor, further cause the processor to associate the first stream-processing platform with a hyper converged storage unit maintained in the first datacenter, wherein data stored in the first filesystem is organized in a hyper converged filesystem of the hyper converged storage unit.
